(19) United States
(12) Patent Application Publication
(10) Pub. No.: US 2012/0173736 A1
(43) Pub. Date: Jul. 5, 2012

(54) METHOD FOR SUPPORTING A USER EQUIPMENT LACKING GLOBALLY ROUTABLE USER AGENT URI - GRUU SUPPORT IN AN INTERNET PROTOCOL MULTIMEDIA SUBSYSTEM - IMS

(75) Inventor: Andreas Klein, Bonn (DE)

(73) Assignee: DEUTSCHE TELEKOM AG, Bonn (DE)

(21) Appl. No.: 13/395,958

(22) PCT Filed: Sep. 16, 2010
(86) PCT No.: PCT/EP10/05695

§ 371 Date: Mar. 14, 2012

Related U.S. Application Data
(60) Provisional application No. 61/243,748, filed on Sep. 18, 2009.

(30) Foreign Application Priority Data
Sep. 18, 2009 (EP) 09011913.2

(51) Int. Cl. G06F 15/16

(52) U.S. Cl. 709/227

(57) ABSTRACT

A Core Network is provided for supporting an Internet Protocol Multimedia Subsystem (IMS) enabled User Equipment (UE), the UE lacking Globally Routable User Agent URI (GRUU) support in an IMS of a communication network. The Core Network includes: an interworking entity, configured to receive a first Session Initiation Protocol (SIP) message from the UE, wherein the first message lacks GRUU-related data, to modify the first SIP message by adding GRUU-related data, to receive a second SIP message to be sent to the UE, wherein the second message includes GRUU-related data, and to modify the second message by removing GRUU-related data. The interworking entity is one of: a Proxy-Call State Control Function (P-CSCF) entity; a Serving-Call State Control Function (S-CSCF) entity; and a Session Border Controller (SBC).

### CROSS-REFERENCE TO RELATED APPLICATIONS

This patent application is a national stage entry under 35 U.S.C. §371 of International Application No. PCT/EP2010/005695, filed Sep. 16, 2010, and claims priority to European Patent Application No. EP09011913.2, filed Sep. 18, 2009, and U.S. Provisional Patent Application No. 61/243,748, filed Sep. 18, 2009. The International Application was published in English on Mar. 24, 2011, as WO 2011/032701 A1.

### FIELD

The present invention relates a core network for supporting a User Equipment (UE) lacking Globally Routable User Agent URI (GRUU) support in an Internet Protocol Multimedia Subsystem (IMS) of a communication network, wherein the Core Network comprises an interworking entity. The present invention further relates to a method for supporting a User Equipment (UE) lacking Globally Routable User Agent URI (GRUU) support in an Internet Protocol Multimedia Subsystem (IMS) of a communication network. The invention further relates to an interworking entity providing a Call State Control Function for supporting a User Equipment (UE) lacking Globally Routable User Agent URI (GRUU) support in an Internet Protocol Multimedia Subsystem (IMS) of a communication network, and a program comprising a computer readable program code.

### BACKGROUND

Communication networks according to the standard of the Internet Protocol Multimedia Subsystem (IMS) are generally known. Several applications of the Session Initiation Protocol (SIP) require a user agent to construct and distribute a Uniform Resource Identifier (URI) that can be used by anyone on the internet to route a call to that specific user agent instance (or User Equipment (UE)). A Uniform Resource Identifier (URI) that routes to a specific user agent instance (or User Equipment (UE)) is called a Globally Routable User Agent URI (GRUU). In the Session Initiation Protocol (SIP), RFC 3261, the basic unit of reference is the Address-Of-Record (AOR).

However, in Session Initiation Protocol (SIP) systems, a single user can have a number of user agents (handsets, softphones, voicemail accounts, etc.) which are all referenced by the same Address-Of-Record (AOR). As the addressing is based on public user ids, a request sent to a public user id will be forked if several clients (user agents or User Equipment (UE) devices) are registered with this public user id at the same time. There are a number of contexts in which it is desirable to have an identifier which addresses a single user agent rather than the group of user agents indicated by an Address-Of-Record (AOR). An example of such a situation is SMS (Short Message Service) over IP (Internet Protocol) which has to communicate directly to dedicated subscribers.

Many current clients attempt to meet the need for an instance-specific identifier by using explicit IP addresses in the values they provide in the Contact header field. However, this interacts poorly with NATs and firewalls, and as a practical matter these Uniform Resource Identifiers (URIs) cannot be used by arbitrary external clients. Similarly, usage of hostnames has proven problematic for similar reasons. In addition, many Session Initiation Protocol (SIP) clients do not have or cannot obtain a hostname for themselves at all. It is therefore useful to provide a unique user-agent (or User Equipment (UE)) identifier which is still globally routable such as a Globally Routable User Agent URI (GRUU), as described, e.g., in European Patent Application EP 1 981 246 A1.

A drawback of the known art is that a User Equipment (UE) which does not support Globally Routable User Agent URI (GRUU) cannot be integrated in such a Session Initiation Protocol (SIP) system as addressing based on Globally Routable User Agent URI (GRUU) works only if the use of Globally Routable User Agent URI (GRUU) is supported by the User Equipment (UE). Generally, for a given User Equipment (UE) device, it is not possible to take Globally Routable User Agent URI (GRUU) support for granted.

### SUMMARY

In an embodiment, the present invention provides a Core Network is for supporting an Internet Protocol Multimedia Subsystem (IMS) enabled User Equipment (UE), the UE lacking Globally Routable User Agent URI (GRUU) support in an IMS of a communication network. The Core Network includes: an interworking entity, configured to: receive a first Session Initiation Protocol (SIP) message from the UE, wherein the first message lacks GRUU-related data; modify the first SIP message by adding GRUU-related data; receive a second SIP message to be sent to the UE, wherein the second message includes GRUU-related data; and modify the second message by removing GRUU-related data. The interworking entity is at least one of: a Proxy-Call State Control Function (P-CSCF) entity; a Serving-Call State Control Function (S-CSCF) entity; and a Session Border Controller (SBC).

### BRIEF DESCRIPTION OF THE DRAWINGS

FIG. 1 schematically illustrates the Subscriber Registration procedure of a User Equipment (UE) to an Internet Protocol Multimedia Subsystem (IMS) of a communication network.

FIG. 2 schematically illustrates the Mobile Terminating procedure of a short message delivery over IP.

FIG. 3 schematically illustrates the Mobile Originating procedure of a short message delivery over IP.

FIG. 4 schematically illustrates the network configuration of an Internet Protocol Multimedia Subsystem (IMS) of a communication network.

### DETAILED DESCRIPTION

In an embodiment, the present invention provides a core network for supporting a User Equipment (UE) lacking Globally Routable User Agent URI (GRUU) support in an Internet Protocol Multimedia Subsystem (IMS) of a communication network.

The Core Network for supporting a User Equipment (UE) lacking Globally Routable User Agent URI (GRUU) support in an Internet Protocol Multimedia Subsystem (IMS) of a communication network includes an interworking entity,

wherein the User Equipment (UE) sends first Session Initiation Protocol (SIP) messages to the interworking entity, the first messages lacking a Globally Routable User Agent URI (GRUU)-related data, and the interworking entity modifying the first messages by adding Globally Routable User Agent URI (GRUU)-related data,

and wherein the interworking entity receives second Session Initiation Protocol (SIP) messages to be sent to the User Equipment (UE), the second messages having a Globally Routable User Agent URI (GRUU)-related data, and the interworking entity modifying the second messages by removing the Globally Routable User Agent URI (GRUU)-related data.

It is thereby advantageously possible that also User Equipment (UE) devices that do not support Globally Routable User Agent URI (GRUU) functionality can be used within a Session Initiation Protocol (SIP) network. This is advantageously possible by way of providing a binding between

a Globally Routable User Agent URI (GRUU),

a public user id (SIP URI), and

an International Mobile Subscriber Identity (IMSI)

to enable a arbitrary entity or node of the communication network, e.g. an Application Server (AS) according to the Session Initiation Protocol (SIP), to easily address specific subscribers (and especially specific User Equipment (UE) of specific subscribers). In an embodiment, the User Equipment (UE) is a Internet Protocol Multimedia Subsystem (IMS) enabled User Equipment (UE). This means that such a User Equipment (UE) does not need to be supported by the interworking function with regard to Internet Protocol Multimedia Subsystem (IMS) functionality as such but only with regard to Globally Routable User Agent URI (GRUU) functionality.

In an embodiment, for the binding between the Globally Routable User Agent URI (GRUU), the public user id (SIP Uniform Resource Identifier (URI)), and the International Mobile Subscriber Identity (IMSI), the User Equipment (UE) is both Internet Protocol Multimedia Subsystem (IMS) enabled and Global System of Mobile communication (GSM) enabled.

In an embodiment, for the case of the second message, the second message is modified such that the Globally Routable User Agent URI (GRUU)-related data are removed and replaced by an initially registered public user id (especially a Session Initiation Protocol (SIP) Uniform Resource Identifier (URI)).

In an embodiment, the Globally Routable User Agent URI (GRUU) related data is a Globally Routable User Agent URI (GRUU) related header field. This means that the first messages are modified in that a Globally Routable User Agent URI (GRUU) related header field is added to the messages and that the second messages are modified in that a Globally Routable User Agent URI (GRUU) related header field is removed from the messages.

It is advantageously possible that the interworking entity is a Proxy-Call State Control Function (P-CSCF) entity or a Serving-Call State Control Function (S-CSCF) entity or a Session Border Controller (SBC).

Thereby, it is advantageously possible that the entity providing the interworking functionality is located as closely as possible to the User Equipment (UE) and that for all or at least for virtually all other nodes of the Internet Protocol Multimedia Subsystem (IMS) communication network, such a User Equipment (UE) [lacking Globally Routable User Agent URI (GRUU) support] can be addressed in a transparent manner as if this User Equipment (UE) had Globally Routable User Agent URI (GRUU) support. In an embodiment, the Proxy-Call State Control Function (P-CSCF) is used as interworking entity because the User Equipment (UE) usually directly contacts (or registers) the Proxy-Call State Control Function (P-CSCF) entity. But also the Serving-Call State Control Function (S-CSCF) can detect that the User Equipment (UE) does not support Globally Routable User Agent URI (GRUU) functionality and start a simulation of procedure.

From a point of view of the User Equipment (UE) or of Session Initiation Protocol (SIP) Application Server (AS), there is no difference if this functionality is implemented by the Proxy-Call State Control Function (P-CSCF) or the Serving-Call State Control Function (S-CSCF) or in the Session Border Controller (SBC). Session Border Controllers (SBC) usually sit between two service provider networks in a peering environment, or between an access network and a backbone network to provide service to residential and/or enterprise customers. The Session Border Controller (SBC) may be hosted in the access network (e.g., this is common when the access network is an enterprise network), or in the operator network (e.g., this is common when the access network is a residential or small business network).

The simulation of the Globally Routable User Agent URI (GRUU) functionality is completely transparent for the Serving-Call State Control Function (S-CSCF) entity and the Application Server (AS). The interworking entity (e.g. the Proxy-Call State Control Function (P-CSCF)) ensures that in all Mobile Originating procedures (or the relating first Session Initiation Protocol (SIP) messages), the Session Initiation Protocol (SIP) Uniform Resource Identifier (URI) in the “FROM” Header is replaced by either the temporary or public Globally Routable User Agent URI (GRUU). Likewise, the interworking entity (e.g. the Proxy-Call State Control Function (P-CSCF)) ensures that in all Mobile Terminating procedures (or the relating second Session Initiation Protocol (SIP) messages), the temporary or public Globally Routable User Agent URI (GRUU) is replaced by the initially registered Session Initiation Protocol (SIP) Uniform Resource Identifier (URI) in the “TO” Header. For User Equipment (UE) devices that support Globally Routable User Agent URI (GRUU), the User Equipment (UE) adds a

“+sip.instance”

parameter containing an instance ID into the contact header of the Session Initiation Protocol (SIP) Register request and the option-tag

“gruu”

in the Supported header in order to obtain a temporary and public Globally Routable User Agent URI (GRUU) from the network. This Session Initiation Protocol (SIP) Register request is sent to the Proxy-Call State Control Function (P-CSCF). The Proxy-Call State Control Function (P-CSCF) checks if the request comprises a

“+sip.instance”

parameter and the option-tag

“gruu”

in the Supported header. The result of this check is positive if the User Equipment (UE) supports Globally Routable User Agent URI (GRUU) functionality.

If—on the other hand—the User Equipment (UE) does not support Globally Routable User Agent URI (GRUU) functionality then the Proxy-Call State Control Function (P-CSCF) has to simulate (or emulate) Globally Routable User Agent URI (GRUU) support of the User Equipment (UE) by adding a

“+sip.instance”

parameter with an arbitrary value into the Contact header of the Session Initiation Protocol (SIP) Register request and the option-tag “gruu” in the Supported header. The simulation of the Globally Routable User Agent URI (GRUU) support means that the Proxy-Call State Control Function (P-CSCF) has to modify all Session Initiation Protocol (SIP) Requests (and other Session Initiation Protocol (SIP) messages) towards the Interrogating-Call State Control Function (I-CSCF) entity and towards the Serving-Call State Control Function (S-CSCF) entity (via the Mw-Interface) (or towards other nodes of the communication network) as if the User Equipment (UE) supported Globally Routable User Agent URI (GRUU). In the context of the present disclosure, such messages are also called first Session Initiation Protocol (SIP) messages or first messages.

The Serving-Call State Control Function (S-CSCF) receives the Session Initiation Protocol (SIP) Register request with the

“+sip.instance”

parameter (i.e. the modified first message) and the option-tag “gruu” in the Supported header and therefore constructs a temporary and public Globally Routable User Agent URI (GRUU). The Serving-Call State Control Function (S-CSCF) binds to the registered public user id, the temporary Globally Routable User Agent URI (GRUU), the public Globally Routable User Agent URI (GRUU) and the International Mobile Subscriber Identity (IMSI). Furthermore, the Serving-Call State Control Function (S-CSCF) sends a third Party Register with the registered public user id to all Application Server (AS) to inform about the registration. By subscribing to the Registration Event Package at the Serving-Call State Control Function (S-CSCF) for such a public user id, the Session Initiation Protocol (SIP) Application Server (AS) will receive the binding between public user id, the temporary Globally Routable User Agent URI (GRUU), the public Globally Routable User Agent URI (GRUU) and the International Mobile Subscriber Identity (IMSI). The logical link of the public user id, the temporary Globally Routable User Agent URI (GRUU), the public Globally Routable User Agent URI (GRUU) and the International Mobile Subscriber Identity (IMSI) enables the Session Initiation Protocol (SIP) Application Server (AS) to communicate directly with a subscriber, even if the Session Initiation Protocol (SIP) Application Server (AS) has only an International Mobile Subscriber Identity (IMSI) as unique identifier, which is not routable in Internet Protocol Multimedia Subsystem (IMS). The Session Initiation Protocol (SIP) Application Server (AS) can map the International Mobile Subscriber Identity (IMSI) to a Globally Routable User Agent URI (GRUU) and use then the Globally Routable User Agent URI (GRUU) for direct communication with a dedicated subscriber (or User Equipment (UE)) in the Internet Protocol Multimedia Subsystem (IMS). Using only the public user id would not be sufficient because the public user ids can be shared and registered by several User Equipments (UEs).

On the other hand (and still in case the User Equipment (UE) does not support Globally Routable User Agent URI (GRUU) functionality), the Proxy-Call State Control Function (P-CSCF) has to remove Globally Routable User Agent URI (GRUU) related data and replace Globally Routable User Agent URIs (GRUUs) by the User Equipments (UEs) Session Initiation Protocol (SIP) Uniform Resource Identifier (URI) in every Session Initiation Protocol (SIP) message towards the User Equipment (UE) (i.e. via the Gm-Interface). In the context of the present disclosure, such messages are also called second Session Initiation Protocol (SIP) messages or second messages.

Such a second message to be transported to the User Equipment (UE) (e.g. the 200 Ok message conveyed to the User Equipment (UE) as a result of the initial Register request) comprises the public and temporary Globally Routable User Agent URI (GRUU). In case the interworking entity, e.g. the Proxy-Call State Control Function (P-CSCF), has simulated Globally Routable User Agent URI (GRUU) support, the interworking entity has to remove all Globally Routable User Agent URI (GRUU) related data in this Session Initiation Protocol (SIP) message which results in the modified second Session Initiation Protocol (SIP) message transported to the User Equipment (UE). The interworking entity stores the temporary and public Globally Routable User Agent URI (GRUU).

Application Servers (AS) which interwork with GSM services (Global System of Mobile communication) like IP-SM GW (IP Short Message GateWay) have to map an International Mobile Subscriber Identity (IMSI) to an Internet Protocol Multimedia Subsystem (IMS) public user id. The International Mobile Subscriber Identity (IMSI) identifies a particular subscriber but the 3GPP standards do not specify how the International Mobile Subscriber Identity (IMSI) can be mapped to a public user id in Internet Protocol Multimedia Subsystem (IMS), which belongs only to this subscriber. Furthermore, a mapping of International Mobile Subscriber Identity (IMSI) to Session Initiation Protocol (SIP) Uniform Resource Identifier (URI) is not sufficient, because a Session Initiation Protocol (SIP) Uniform Resource Identifier (URI) can be shared by several User Equipments (UEs). According to the present invention and by way of creating a link between a public user id (Session Initiation Protocol (SIP) Uniform Resource Identifier (URI)), Globally Routable User Agent URI (GRUU) and International Mobile Subscriber Identity (IMSI), it is advantageously possibly for the Application Server (AS) to map an International Mobile Subscriber Identity (IMSI) to a Globally Routable User Agent URI (GRUU) for addressing only a dedicated User Equipment (UE) (out of a plurality of User Equipments (UEs) associated with a specific subscriber.

In an embodiment, the Globally Routable User Agent URI (GRUU)-related data comprises a public and a temporary Globally Routable User Agent URI (GRUU).

Thereby, it is advantageously possible that full support for all kinds of Globally Routable User Agent URI (GRUU) identities is possible.

An embodiment of the present invention also relates to a Method for supporting a User Equipment (UE) lacking Globally Routable User Agent URI (GRUU) support in an Internet Protocol Multimedia Subsystem (IMS) of a communication network, the communication network comprising an interworking entity, the method comprising the steps of:

the User Equipment (UE) sending first Session Initiation Protocol (SIP) messages to the interworking entity, the first messages lacking a Globally Routable User Agent URI (GRUU)-related data, and the interworking entity modifying the first messages by adding Globally Routable User Agent URI (GRUU)-related data,

and the interworking entity receiving second Session Initiation Protocol (SIP) messages to be sent to the User Equipment (UE), the second messages having a Globally Routable User Agent URI (GRUU)-related data, and the interworking entity modifying the second messages by removing the Globally Routable User Agent URI (GRUU)-related data.

It is thereby advantageously possible that the use of User Equipments (UEs) without Globally Routable User Agent URI (GRUU) support is possible within an internet Protocol Multimedia Subsystem (IMS) communication network.

An embodiment of the present invention also relates to an Interworking entity providing a Call State Control Function for supporting a User Equipment (UE) lacking Globally Routable User Agent URI (GRUU) support in an Internet Protocol Multimedia Subsystem (IMS) of a communication network,

wherein the User Equipment (UE) sends first Session Initiation Protocol (SIP) messages to the interworking entity, the first messages lacking a Globally Routable User Agent URI (GRUU)-related data, and the interworking entity modifying the first messages by adding Globally Routable User Agent URI (GRUU)-related data,

and wherein the interworking entity receives second Session Initiation Protocol (SIP) messages to be sent to the User Equipment (UE), the second messages having a Globally Routable User Agent URI (GRUU)-related data, and the interworking entity modifying the second messages by removing the Globally Routable User Agent URI (GRUU)-related data.

Additionally, an embodiment of the present invention relates to a program comprising a computer readable program code for controlling an Interworking entity.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In all Figures, the assumption is met that the User Equipment (UE) does not support Globally Routable User Agent URI (GRUU) functionality. This means that the User Equipment (UE) does not send messages to the core network that comprise any Globally Routable User Agent URI (GRUU) header parameters. Accordingly, the User Equipment (UE) is not able to correctly interpret messages received from the core network that contain Globally Routable User Agent URI (GRUU) related parameters and at best ignores such parts of received messages

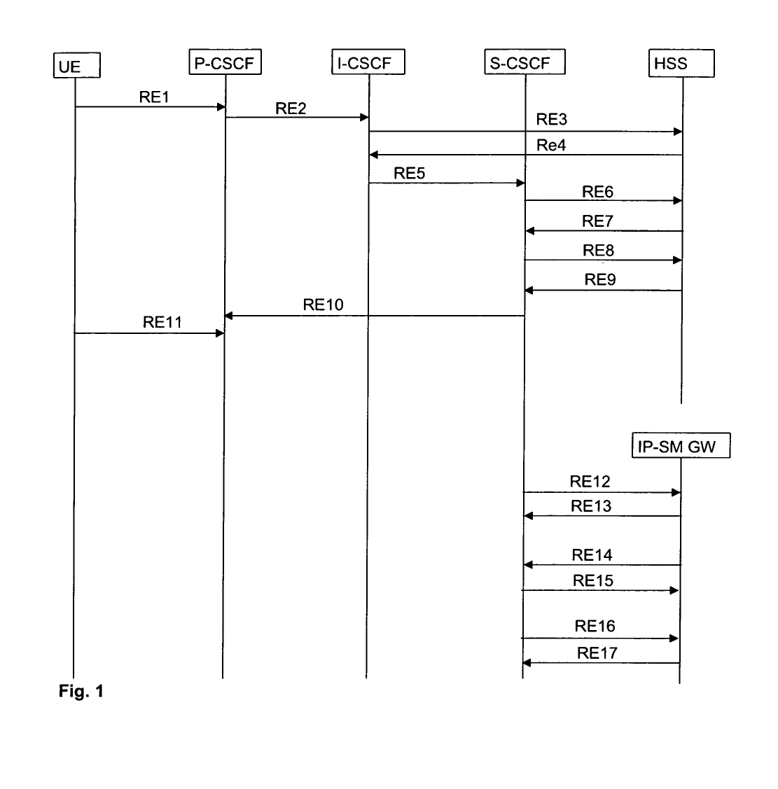

In FIG. 1, the Subscriber Registration procedure of a User Equipment (UE) to an Internet Protocol Multimedia Subsystem (IMS) of a communication network is schematically shown by way of illustrating the message exchange between a number of entities of the communication network, namely the User Equipment (UE), a Proxy-Call State Control Function (P-CSCF), an interrogating-Call State Control Function (I-CSCF), a Serving-Call State Control Function (S-CSCF), a Home Subscriber Server (HSS) and an Internet Protocol (IP) Short Message GateWay (IP-SM GW). A first step of the Registration procedure, designated by RE1, corresponds to the User Equipment (UE) sending the initial Session Initiation Protocol (SIP) Register request. The initial Session Initiation Protocol (SIP) Register request corresponds to a message that does not comprise any Globally Routable User Agent URI (GRUU) related parameters or information. In the following, an example of such an initial Session Initiation Protocol (SIP) Register request is given:

REGISTER sip:t-mobile.net SIP/2.0
...
Contact: <sip:491714358392@10.103.2.1>
Content-Length: 0

A second step of the Registration procedure, designated by RE2, corresponds to the Proxy-Call State Control Function (P-CSCF) entity detecting that the User Equipment (UE) does not support Globally Routable User Agent URI (GRUU). For this reason, the Proxy-Call State Control Function (P-CSCF) entity simulates the Globally Routable User Agent URI (GRUU) support by adding a

“+sip.instance”

header and Globally Routable User Agent URI (GRUU) support indication to the Register message. In the following, an example of such a message is given:

REGISTER sip:t-mobile.net SIP/2.0
...
Supported: gruu
...
Contact: <sip:491714358392@10.103.2.1>

;+sip.instance=“<urn:uuid:f81d4fae-7dec-11d0-a765-00a0c91e6bf6>”

Content-Length: 0

This message RE2 of the second step of the Registration procedure is sent to the Interrogating-Call State Control Function (I-CSCF) entity.

A third, fourth, fifth, sixth, seventh and eighth step of the Registration procedure, designated by RE3, RE4, RE5, RE6, RE7, RE8, correspond to the assignment of a Serving-Call State Control Function (S-CSCF) entity (by the Interrogating-Call State Control Function (I-CSCF) entity). This includes performing of the authentication (e.g. by way of GIBA (GPRS IMS Bundled Authentication) authentication), the assignment of the Serving-Call State Control Function (S-CSCF) entity and the download of the service profile from the Home Subscriber Server (HSS). The third step RE3 corresponds to UAR (User-Authorization-Request). The fourth step RE4 corresponds to UAA (User-Authorization-Answer). The fifth step RE5 corresponds to the Interrogating-Call State Control Function (I-CSCF) assignment by way of a REGISTER message. The sixth step RE6 corresponds to MAR (Multimedia-Auth-Request). The seventh step RE7 corresponds to MAA (Multimedia-Auth-Answer). The eighth step RE8 corresponds to SAR (Server-Assignment-Request). The ninth step RE9 corresponds to SAA (Server-Assignment-Answer).

In a tenth step of the Registration procedure, designated by RE10, the Serving-Call State Control Function (S-CSCF) entity assigns a temporary and a public Globally Routable User Agent URI (GRUU), which is conveyed to the User Equipment (UE) in a 200 Ok message. Despite the fact that the User Equipment (UE) does not support Globally Routable User Agent URI (GRUU) functionality, this assignment of the temporary and public Globally Routable User Agent URI (GRUU) is possible because the Globally Routable User Agent URI (GRUU) support is emulated by the Proxy-Call State Control Function (P-CSCF) entity. In the following, an example of such a 200 Ok and assignment message is given:

SIP/2.0 200 OK
...
Contact: <sip:491714358392@10.103.2.1>

;pub-gruu=“sip:491714358392@t-mobile.net
;gr=urn:uuid:f81d4fae-7dec-11d0-

a765-00a0c91e6bf6”

;temp-gruu=“sip:asdfj93jop24jlv93kl@t-mobile.net;gr”
;+sip.instance=“<urn:uuid:f81d4fae-7dec-11d0-a765-00a0c91e6bf6>”

Content-Length: 0

An eleventh step of the Registration procedure, designated by RE11, corresponds to the Proxy-Call State Control Function (P-CSCF) entity filtering out all Globally Routable User Agent URI (GRUU) related data and saves the temporary and public Globally Routable User Agent URI (GRUU). The “clean” (i.e. modified) 200 Ok message is forwarded to the User Equipment (UE) and the subscriber is registered. In the following, an example of such a modified 200 Ok message is given:

SIP/2.0 200 OK
...
Contact: <sip:491714358392@10.103.2.1>
Content-Length: 0

A twelfth step of the Registration procedure, designated by RE12, corresponds to the Serving-Call State Control Function (S-CSCF) entity informing the IP-SM GW that a new public user id is registered. This is acknowledged by a thirteenth step of the Registration procedure, designated by RE13, consisting in a 200 Ok message.

A fourteenth step of the Registration procedure, designated by RE14, corresponds to the IP-SM GW subscribing for the Reg Event Package of this public user id. This is acknowledged by a fifteenth step of the Registration procedure, designated by RE15, consisting in a 200 Ok message.

A sixteenth step of the Registration procedure, designated by RE16, corresponds to the Serving-Call State Control Function (S-CSCF) entity sending a Notify message with the Registration Information to the IP-SM GW, which contains the link between public user id (Session Initiation Protocol (SIP) Uniform Resource Identifier (URI)), temporary Globally Routable User Agent URI (GRUU), public Globally Routable User Agent URI (GRUU) and International Mobile Subscriber Identity (IMSI). This is acknowledged by a seventeenth step of the Registration procedure, designated by RE17, consisting in a 200 Ok message. In the following, an example of such a Notify message is given:

Notify
...
Content-Length: ...
<?xml version=“1.0”?>

<reginfo xmlns=“urn:ietf:params:xml:ns:reginfo” version=“0” state=“full”>

<registration aor=“sip:491714358392@t-mobile.net” id=“as9”

state=“active”>

```
<contact id=“76” state=“active” event=“registered”>
  <uri>sip:[5555::aaa:bbb:ccc:ddd]</uri>
  <unknown-param name=“+sip.instance”>
```

“&lt;urn:uuid:f81d4fae-7dec-11d0-a765-00a0c91e6bf6&gt;”

</unknown-param>
<gr:pub-gruu uri=“491714358392@t-mobile.net;gr=hha9s8d-999a”/>

<gr:temp-gruu uri=“sip:asdfj93jop24jlv93kl@t-mobile.net;gr” first-

cseq=“54301”/>

<IMSI>2620112345678</IMSI>

</contact>

</registration>

</reginfo>

In the case the UE subscribes also the Reg Event Package of the registered public user id in the steps above, Proxy-Call State Control Function (P-CSCF) has to filter out all Globally Routable User Agent URI (GRUU) related data in the Session Initiation Protocol (SIP) Notify message.

In FIG. 2, the Mobile Terminating procedure of a short message delivery over IP is schematically shown by way of illustrating the message exchange between a number of entities of the communication network, namely the User Equipment (UE), a Proxy-Call State Control Function (P-CSCF), a Serving-Call State Control Function (S-CSCF) and an Internet Protocol (IP) Short Message Gateway (IP-SM GW).

A first step of the Mobile Terminating procedure, designated by MT1, corresponds to the IP-SM GW receiving a Short Message and extracts the International Mobile Subscriber Identity (IMSI) from the received message.

A second step of the Mobile Terminating procedure, designated by MT2, corresponds to the IP-SM GW creating a Session Initiation Protocol (SIP) message containing the Short Message and a public Globally Routable User Agent URI (GRUU) as Request Uniform Resource Identifier (URI), which is associated with the received International Mobile Subscriber Identity (IMSI). The IP-SM GW received the association between International Mobile Subscriber Identity (IMSI) and Globally Routable User Agent URI (GRUU) as it subscribed to this user's Reg Event Package before (cf. FIG. 1), i.e. the binding between the Globally Routable User Agent URI (GRUU) and the International Mobile Subscriber Identity (IMSI) is used. In the following, an example of such a Session Initiation Protocol (SIP) message is given:

MESSAGE
...
To: <sip:491714358392@t-mobile.net
;gr=urn:uuid:f81d4fae-7dec-11d0-a765-
00a0c91e6bf6>
...
Content-Type: application/vnd.3gpp.sms
Content-Length: (...

A third step of the Mobile Terminating procedure, designated by MT3, corresponds to the Serving-Call State Control Function (S-CSCF) entity forwarding the message to the Proxy-Call State Control Function (P-CSCF) entity.

A fourth step of the Mobile Terminating procedure, designated by MT4, corresponds to the Proxy-Call State Control Function (P-CSCF) entity replacing the Globally Routable User Agent URI (GRUU) with the Session Initiation Protocol (SIP) Uniform Resource Identifier (URI), which was originally registered by the subscriber. In the following, an example of such a Session Initiation Protocol (SIP) message is given:

MESSAGE
...
To: <sip:491714358392@t-mobile.net>
...
Content-Type: application/vnd.3gpp.sms
Content-Length: (...)

A fifth step of the Mobile Terminating procedure, designated by MT5, corresponds to the User Equipment (UE) acknowledging the Short Message with a 200 Ok message. In the following, an example of such a message is given:

SIP/2.0 200 OK
...
From: <sip:491714358392@t-mobile.net>
...

A sixth step of the Mobile Terminating procedure, designated by MT6, corresponds to the Proxy-Call State Control Function (P-CSCF) entity replacing the Session Initiation Protocol (SIP) Uniform Resource Identifier (URI) in the “From” Header with the public Globally Routable User Agent URI (GRUU) from the message in the second step MT2 of the Mobile Terminating procedure. In the following, an example of such a modified message is given:

SIP/2.0 200 OK
...
From: <sip:491714358392@t-mobile.net
;gr=urn:uuid:f81d4fae-7dec-11d0-a765-
00a0c91e6bf6>
...

A seventh step of the Mobile Terminating procedure, designated by MT7, corresponds to the forwarding of a 200 Ok message to the IP-SM GW.

An eighth step of the Mobile Terminating procedure, designated by MTB, corresponds to the User Equipment (UE) sending the SMS Delivery Report in a Session Initiation Protocol (SIP) Message to the IP-SM GW. In the following, an example of such a message is given:

MESSAGE
...
From: <sip:491714358392@t-mobile.net>
...
Content-Type: application/vnd.3gpp.sms
Content-Length: (...)

A ninth step of the Mobile Terminating procedure, designated by MT9, corresponds to the Proxy-Call State Control Function (P-CSCF) entity replacing the Session Initiation Protocol (SIP) Uniform Resource Identifier (URI) in the “From” Header with the public Globally Routable User Agent URI (GRUU) corresponding to this User Equipment (UE) (from the message in the second step MT2 of the Mobile Terminating procedure). In the following, an example of such a modified message is given:

MESSAGE
...
From: <sip:491714358392@t-mobile.net;gr=urn:uuid:f81d4fae-7dec-11d0-a765-
00a0c91e6bf6>
...
Content-Type: application/vnd.3gpp.sms
Content-Length: (...)

A tenth step of the Mobile Terminating procedure, designated by MT10, corresponds to the forwarding of the Session Initiation Protocol (SIP) message to the IP-SM GW.

An eleventh step of the Mobile Terminating procedure, designated by MT11, corresponds to the answering of the IP-SM GW by way of a 202 Accepted message.

A twelfth step of the Mobile Terminating procedure, designated by MT12, corresponds to the Serving-Call State Control Function (S-CSCF) entity forwarding the 202 Accepted message in a form comprising the Globally Routable User Agent URI (GRUU) related information. In the following, an example of such a message is given:

SIP/2.0 202 Accepted
...
To: <sip:491714358392@t-mobile.net;
gr=urn:uuid:f81d4fae-7dec-11d0-a765-
00a0c91e6bf6>
...

A thirteenth step of the Mobile Terminating procedure, designated by MT13, corresponds to the Proxy-Call State Control Function (P-CSCF) entity forwarding the 202 Accepted message to the User Equipment (UE). Before this message is forwarded, the Proxy-Call State Control Function (P-CSCF) entity replaces the Globally Routable User Agent URI (GRUU) in the “To” header with the Session Initiation Protocol (SIP) Uniform Resource Identifier (URI) which was originally registered by the subscriber (the User Equipment (UE)). In the following, an example of such a message is given:

SIP/2.0 200 OK
...
To: <sip:491714358392@t-mobile.net>
...

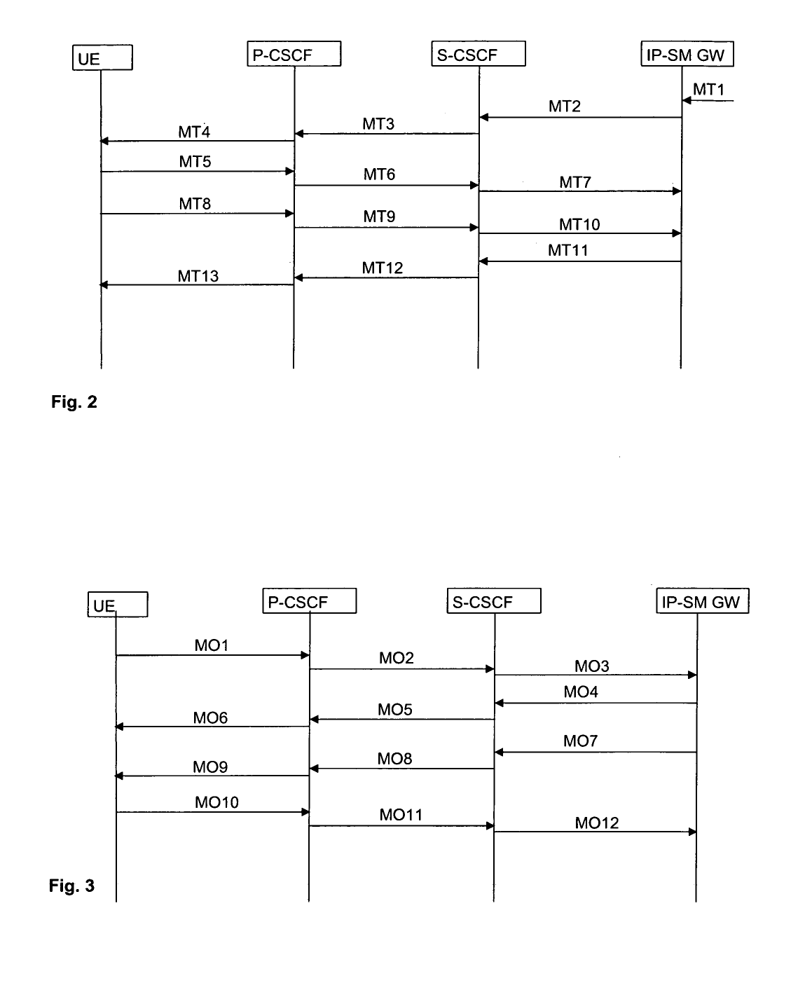

In FIG. 3, the Mobile Originating procedure of a short message delivery over IP is schematically shown by way of illustrating the message exchange between a number of entities of the communication network, namely the User Equipment (UE), a Proxy-Call State Control Function (P-CSCF), a Serving-Call State Control Function (S-CSCF) and an Internet Protocol (IP) Short Message Gateway (IP-SM GW).

A first step of the Mobile Originating procedure, designated by MO1, corresponds to the User Equipment (UE) including the Short Message in the payload of a Session Initiation Protocol (SIP) message directed to the Proxy-Call State Control Function (P-CSCF). In the following, an example of such a Session Initiation Protocol (SIP) message is given:

MESSAGE
...
From: <sip:491714358392@t-mobile.net>
...
Content-Type: application/vnd.3gpp.sms
Content-Length: (...)

A second step of the Mobile Originating procedure, designated by MO2, corresponds to Proxy-Call State Control Function (P-CSCF) replacing the Session Initiation Protocol (SIP) Uniform Resource Identifier (URI) in the “From” header with the public Globally Routable User Agent URI (GRUU) corresponding to the requesting or contacting User Equipment (UE). In the following, an example of such a Session Initiation Protocol (SIP) message is given:

MESSAGE
...
From: <sip:491714358392@t-mobile.net
;gr=urn:uuid:f81d4fae-7dec-11d0-a765-
00a0c91e6bf6>
...
Content-Type: application/vnd.3gpp.sms
Content-Length: (...)

A third step and a fourth step of the Mobile Originating procedure, designated by MO3 and MO4, correspond to the forwarding of the message by the Serving-Call State Control Function (S-CSCF) entity to the IP-SM GW (third step) and the answering of the IP-SM GW by way of a 202 Accepted message.

A fifth and sixth step of the Mobile Originating procedure, designated by MO5 and MO6, correspond to the Proxy-Call State Control Function (P-CSCF) entity receiving the 202 Accepted message from the Serving-Call State Control Function (S-CSCF) entity and the replacement of the Globally Routable User Agent URI (GRUU) in the “To” header with the Session Initiation Protocol (SIP) Uniform Resource Identifier (URI) which was originally registered by the User Equipment (UE)/the subscriber. In the following, an example of a message received by the Proxy-Call State Control Function (P-CSCF) entity is given:

SIP/2.0 202 Accepted
...
To: <sip:491714358392@t-mobile.net
;gr=urn:uuid:f81d4fae-7dec-11d0-a765-
00a0c91e6bf6>
...

In the following, an example of such a modified message is given:

SIP/2.0 200 OK
...
To: <sip:491714358392@t-mobile.net>
...

After reception of the Short Message by the IP-SM GW, the Short Message is extracted and forwarded to other parts of the core network (e.g. the service center) in order to transmit the Short message to its destination. This can be performed by using the binding between the Globally Routable User Agent URI (GRUU) and the International Mobile Subscriber Identity (IMSI). The IP-SM GW then waits for the delivery report. These steps of the procedure are not explicitly shown in FIG. 3. A seventh step of the Mobile Originating procedure, designated by MO7, corresponds to the sending of the SMS-Submit-Report in a Session Initiation Protocol (SIP) message to the User Equipment (UE). In the following, an example of such a message is given:

MESSAGE
...
To: <sip:491714358392@t-mobile.net
;gr=urn:uuid:f81d4fae-7dec-11d0-a765-
00a0c91e6bf6>
...
Content-Type: application/vnd.3gpp.sms
Content-Length: (...)

An eighth step of the Mobile Originating procedure, designated by MO8, corresponds to the Serving-Call State Control Function (S-CSCF) entity forwarding the Session Initiation Protocol (SIP) message to the Proxy-Call State Control Function (P-CSCF).

A ninth step of the Mobile Originating procedure, designated by MO9, corresponds to the Proxy-Call State Control Function (P-CSCF) entity replacing the Globally Routable User Agent URI (GRUU) in the “To” Header with the Session Initiation Protocol (SIP) Uniform Resource Identifier (URI), which was originally registered by the User Equipment (UE)/subscriber. Then, the modified Session Initiation Protocol (SIP) message is forwarded to the User Equipment (UE). In the following, an example of such a modified message is given:

MESSAGE
...
To: <sip:491714358392@t-mobile.net>
...
Content-Type: application/vnd.3gpp.sms
Content-Length: (...)

A tenth step of the Mobile Originating procedure, designated by MO10, corresponds to acknowledging of the User Equipment (UE) of the Session Initiation Protocol (SIP) message with a 200 Ok message. In the following, an example of such a message is given:

SIP/2.0 200 OK
...
From: <sip:491714358392@t-mobile.net>
...

An eleventh step of the Mobile Originating procedure, designated by MO11, corresponds to transmitting the answer from the Proxy-Call State Control Function (P-CSCF) entity to the Serving-Call State Control Function (S-CSCF) entity and prior of this transmission the replacement of the Session Initiation Protocol (SIP) Uniform Resource Identifier (URI) in the “From” header with the public Globally Routable User Agent URI (GRUU) from the tenth step of the Register procedure (RE10, cf. FIG. 1). In the following, an example of such a message is given:

SIP/2.0 200 OK
...
From: <sip:491714358392@t-mobile.net;gr=urn:uuid:f81d4fae-7dec-11d0-a765-
00a0c91e6bf6>
...

A twelfth step of the Mobile Originating procedure, designated by MO12, corresponds to the Serving-Call State Control Function (S-CSCF) entity forwarding the 200 Ok message in a form comprising the Globally Routable User Agent URI (GRUU) related information to the IP-SM GW.

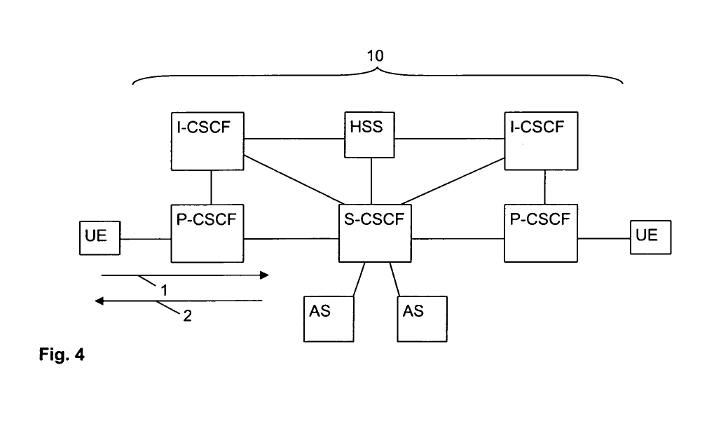

FIG. 4 schematically illustrates the network configuration of a core network 10 providing the functionality of the Internet Protocol Multimedia Subsystem (IMS) in a communication network. Two User Equipment (UE) devices are illustrated in FIG. 4. The two User Equipment (UE) devices represent a plurality of User Equipment (UE) devices that contact the network, i.e. that are related to arbitrary subscribers.

The core network 10 comprises a Proxy-Call State Control Function (P-CSCF) entity related to each of the User Equipment devices (UEs). Furthermore, the core network 10 comprises a Serving-Call State Control Function (S-CSCF) serving both UEs. Furthermore, the core network 10 comprises an Interrogating-Call State Control Function (I-CSCF) entity associated to each Proxy-Call State Control Function (P-CSCF) entity. The Interrogating-Call State Control Function (I-CSCF) entities are linked to a Home Subscriber Server (HSS), to one of the Proxy-Call State Control Function (P-CSCF) entities and to the Serving-Call State Control Function (S-CSCF) entity and the Serving-Call State Control Function (S-CSCF) entity is linked to one or more Application Server (AS) and the HSS, respectively.

In the examples explained with respect to FIGS. 1 to 3, the registration procedure and the Mobile Terminating and Mobile Originating procedure of a Short Message transmission over IP are illustrated for the case that at least one of the User Equipment devices (UEs) do not have Globally Routable User Agent URI (GRUU) support.

A translation or modification of first messages 1 originating from the User Equipment (UE) and directed to an entity of the core network 10 is performed. This translation or modification of the first messages is done by replacing a first identification information (the Session Initiation Protocol (SIP) Uniform Resource Identifier (URI)) by a second identification information (the Globally Routable User Agent URI (GRUU)) resulting in a modified first message 1.

Furthermore, a translation or modification of second messages 2 directed to the User Equipment (UE) and originating at an entity of the core network 10 is performed. This translation or modification of the second messages 2 is done

either by replacing the second identification information (the Globally Routable User Agent URI (GRUU)) by the first identification information (the Session Initiation Protocol (SIP) Uniform Resource Identifier (URI)),

or by deleting Globally Routable User Agent URI (GRUU) related data resulting in a modified second message 2.

This translation and replacement can either be made within the Proxy-Call State Control Function (P-CSCF) entity or within the Serving-Call State Control Function (S-CSCF) entity. Only the case of the translation and replacement within the Proxy-Call State Control Function (P-CSCF) is illustrated in the Figures and explained.

In a further embodiment, third messages can be exchanged within the core network 10 and/or between an entity of the core network 10 and a User Equipment (UE) device, wherein the third messages are not modified by the interworking entity. The decision of which message is treated as a third message on the one hand or as a first or second message on the other hand can be implemented by way of decision rules defined within the core network and/or stored within the interworking entity. Depending on the Session Initiation Protocol (SIP) request method, e.g. a Register request or a Invite request, a given message can be treated as a third message (i.e. no modification occurs) or as a first or second message (i.e. modification/replacement occurs).

In the Mobile Terminating case (FIG. 2), the modification of the first message 1 occurs, e.g., at the sixth step (i.e. the corresponding non-modified first message 1 is sent from the User Equipment (UE) to the Proxy-Call State Control Function (P-CSCF) entity in the fifth step MT5 and the translation and forwarding to the Serving-Call State Control Function (S-CSCF) occurs in the sixth step MT6) and at the ninth step (i.e. the corresponding non-modified first message 1 is sent from the User Equipment (UE) to the Proxy-Call State Control Function (P-CSCF) entity in the eighth step MT8 and the translation and forwarding to the Serving-Call State Control Function (S-CSCF) occurs in the ninth step MT9).

In the Mobile Originating case (FIG. 3), this modification of the first message 1 occurs, e.g., at the second step (i.e. the corresponding non-modified first message 1 is sent from the User Equipment (UE) to the Proxy-Call State Control Function (P-CSCF) entity in the first step MO1 and the translation and forwarding to the Serving-Call State Control Function (S-CSCF) occurs in the second step MO2) and at the eleventh step (i.e. the corresponding non-modified first message 1 is sent from the User Equipment (UE) to the Proxy-Call State Control Function (P-CSCF) entity in the tenth step MO10 and the translation and forwarding to the Serving-Call State Control Function (S-CSCF) occurs in the eleventh step MO11).

In the Mobile Terminating case (FIG. 2), the modification of a second message 2 occurs, e.g., at the fourth step (i.e. the corresponding non-modified second message 2 is sent from Serving-Call State Control Function (S-CSCF) entity to the Proxy-Call State Control Function (P-CSCF) entity in the third step MT3 and the translation and forwarding to the User Equipment (UE) occurs in the fourth step MT4) and at the thirteenth step (i.e. the corresponding non-modified second message 2 is sent from Serving-Call State Control Function (S-CSCF) entity to the Proxy-Call State Control Function (P-CSCF) entity in the twelfth step MT12 and the translation and forwarding to the User Equipment (UE) occurs in the thirteenth step MT13).

In the Mobile Originating case (FIG. 3), this modification of the second message 2 occurs, e.g., at the sixth step (i.e. the corresponding non-modified second message 2 is sent from Serving-Call State Control Function (S-CSCF) entity to the Proxy-Call State Control Function (P-CSCF) entity in the fifth step MO5 and the translation and forwarding to the User Equipment (UE) occurs in the sixth step MO6) and at the ninth step (i.e. the corresponding non-modified second message 2 is sent from Serving-Call State Control Function (S-CSCF) entity to the Proxy-Call State Control Function (P-CSCF) entity in the eighth step MO8 and the translation and forwarding to the User Equipment (UE) occurs in the ninth step MO9).

1-15. (canceled)

14. A Core Network for supporting an Internet Protocol Multimedia Subsystem (IMS) enabled User Equipment (UE), the UE lacking Globally Routable User Agent URI (GRUU) support in an IMS of a communication network, the Core Network (10) comprising:
an interworking entity, configured to:
receive a first Session Initiation Protocol (SIP) message from the UE, wherein the first SIP message lacks GRUU-related data;
modify the first SIP message by adding GRUU-related data;
receive a second SIP message to be sent to the UE, wherein the second message includes GRUU-related data; and
modify the second message by removing GRUU-related data;
wherein the interworking entity is at least one of:
a Proxy-Call State Control Function (P-CSCF) entity;
a Serving-Call State Control Function (S-CSCF) entity; and
a Session Border Controller (SBC).

15. The Core Network according to claim 14, wherein the GRUU-related data comprises a public and temporary GRUU.

16. The Core Network according to claim 14, wherein the interworking entity is the S-CSCF entity, and the S-CSCF entity is configured to generate an SIP message comprising a binding between a GRUU, a public user id (SIP URI), and an International Mobile Subscriber Identity (IMSI).

17. The Core Network according to claim 16, wherein the UE is both IMS enabled and Global System of Mobile communication (GSM) enabled.

18. A method for supporting an Internet Protocol Multimedia Subsystem (IMS) enabled User Equipment (UE) in an IMS of a communication network, wherein the UE lacks Globally Routable User Agent URI (GRUU) support and the communication network comprises an interworking entity, the method comprising:
receiving, by the interworking entity, a first Session Initiation Protocol (SIP) message from the UE, wherein the first SIP message lacks. GRUU-related data;
modifying, by the interworking entity, the first SIP message by adding GRUU-related data;
receiving, by the interworking entity, a second SIP message to be sent to the UE, wherein the second SIP message includes GRUU-related data; and
modifying, by the interworking entity, the second SIP message by removing GRUU-related data;
wherein the interworking entity is at least one of:
a Proxy-Call State Control Function (P-CSCF) entity;
a Serving-Call State Control Function (S-CSCF) entity; and
a Session Border Controller (SBC).

19. The method according to claim 18, wherein the GRUU-related data comprises a public and temporary GRUU.

20. The method according to claim 18, wherein the interworking entity is the S-CSCF entity, and the S-CSCF entity is configured to generate an SIP message comprising a binding between a GRUU, a public user id (SIP URI), and an International Mobile Subscriber Identity (IMSI).

21. The method according to claim 20, wherein the UE is both IMS enabled and Global System of Mobile communication (GSM) enabled.

22. A tangible, non-transitory computer-readable medium, part of an interworking entity, having computer-executable instructions stored thereon for supporting an Internet Protocol Multimedia Subsystem (IMS) enabled User Equipment (UE) in an IMS of a communication network, wherein the UE lacks Globally Routable User Agent URI (GRUU) support and the communication network comprises the interworking entity, wherein the interworking entity is at least one of a Proxy-Call State Control Function (P-CSCF) entity, a Serving-Call State Control Function (S-CSCF) entity, and a Session Border Controller (SBC), the computer-executable instructions comprising instructions for:
receiving a first Session Initiation Protocol (SIP) message from the UE, wherein the first SIP message lacks GRUU-related data;
modifying the first SIP message by adding GRUU-related data;
receiving a second SIP message to be sent to the UE, wherein the second SIP message includes GRUU-related data; and
modifying the second SIP message by removing GRUU-related data.

23. The tangible, non-transitory computer readable medium according to claim 22, wherein the GRUU-related data comprises a public and temporary GRUU.

24. The tangible, non-transitory computer-readable medium according to claim 22, wherein the interworking entity is the S-CSCF entity, and the S-CSCF entity is configured to generate an SIP message comprising a binding between a GRUU, a public user id (SIP URI), and an International Mobile Subscriber Identity (IMSI).

25. The tangible, non-transitory computer-readable medium according to claim 24, wherein the UE is both IMS enabled and Global System of Mobile communication (GSM) enabled.
